(19) United States
(12) Patent Application Publication
(10) Pub. No.: US 2009/0107785 A1
(43) Pub. Date: Apr. 30, 2009

(54) HYDRAULIC SHOCK ABSORBER

(75) Inventor: Osamu NAGAI, Shizuoka (JP)

Correspondence Address: ORUM & ROTH LLC, 53 W. JACKSON BLVD., SUITE 1616, CHICAGO, IL, 60604, US

(73) Assignee: SHOWA CORPORATION, Saitama (JP)

(21) Appl. No.: 12/139,229

(22) Filed: Jun. 13, 2008

(30) Foreign Application Priority Data
Oct. 30, 2007 (JP) 2007-282266

(51) Int. Cl. B60G 13/08; F16F 9/18

(52) U.S. Cl. 188/315; 267/124; 267/2

(57) ABSTRACT

In a hydraulic shock absorber, an outer operating oil chamber within an inner tube is communicated with a piston rod side oil chamber within a cylinder, an annular oil chamber is compartmentalized between an inner periphery of an outer tube and an outer periphery of the inner tube, the annular oil chamber is communicated with the outer operating oil chamber within the inner tube via an oil hole provided in the inner tube, a cross sectional area of the annular oil chamber is formed larger than a cross sectional area of a piston rod, and the hydraulic shock absorber has a volume compensating flow path which circulates the oil in an inner operating oil chamber or the outer operating oil chamber to an oil reservoir chamber in an expansion aside stroke in which the piston rod outgoes from the inner operating oil chamber, and a check valve which prevents the oil flow from the inner operating oil chamber or the outer operating oil chamber to the oil reservoir chamber in the expansion side stroke.

### BACKGROUND OF THE INVENTION

1. Field of the Invention

The present invention relates to a hydraulic shock absorber for a vehicle.

2. Description of the Related Art

Regarding a hydraulic shock absorber for a front fork or the like, as described in Japanese Unexamined Patent Application Laid-Open (JP-A) No. 2003-269515 (patent document 1), there is a hydraulic shock absorber for a vehicle in which an inner tube is slidably inserted into an outer tube via bushes which are fixed to each of an opening portion m an inner periphery of the outer tube, a leading end portion of an outer periphery of the inner tube. An annular oil chamber is compartmentalized so as to be surrounded by the inner periphery of the outer tube, the outer periphery of the inner tube and the two bushes. A partition wail member is provided in an inner periphery of the inner tube. An oil chamber is compartmentalized in a lower portion, an oil reservoir chamber is compartmentalized in an upper portion. A piston rod attached to the outer tube is slidably inserted to the partition wail member. A piston sliding within the inner tube is fixed to a leading end portion of the piston rod inserted to the inner tube. The oil chamber is compartmentalized into a piston rod side oil chamber in which the piston rod is accommodated and a piston side oil chamber in which the piston rod is not accommodated, and the annular oil chamber is communicated with the piston rod side oil chamber or the piston side oil chamber via an oil hole provided in the inner tube, wherein a cross sectional area of the annular oil chamber is formed larger than a cross sectional area of the piston rod. The partition wail member is provided with a check valve preventing a flow from the oil chamber into the oil reservoir chamber during an expansion Aside stroke, and the partition wail member is provided with a volume compensating small flow path passing through the oil chamber and the oil reservoir chamber

In this conventional hydraulic shock absorber, an operating oil at an approaching volume of the piston rod going into the inner tube in a compression side stroke is transferred to the annular oil chamber through the oil hole of the inner tube from the oil chamber within the inner tube. At this time, since a volume increment amount ΔS1 (a supply amount) of the annular chamber is larger than a volume increment amount ΔS2 of the piston rod, a shortfall amount (ΔS1−ΔS2) in a necessary supply amount, of the oil to the annular oil chamber is supplied from the oil reservoir chamber via the check valve. Further, the operating oil at an outgoing volume of the piston rod outgoing from the inner tube in the expansion side stroke is transferred to the oil chamber within the inner tube from the annular oil chamber through the oil hole of the inner tube. At this time, since a volume decrement amount ΔS1 (a discharge amount) of the annular oil chamber is larger than a volume decrement amount ΔS2 of the pi,ton rod, a surplus amount (ΔS1−ΔS2) in a discharge amount of the oil from the annular oil chamber is discharged to the oil reservoir chamber through the small flow path. In this expansion side stroke, a passage resistance of the small flow path generates an expansion, side damping force.

The hydraulic shock absorber described in the patent document 1 has the following problem.

(1) A damping force generated by a damping valve apparatus provided in the piston of the hydraulic shock absorber is obtained by multiplying a pressure difference ΔP between the piston rod side oil chamber and the piston side oil chamber in both sides of the piston by a piston area A. In the case that it is intended to make the damping force small for improving a riding quality of the vehicle, it is necessary to apply a fixed rigidity to the valve for securing a durability of the valve. Accordingly, there is a limit in making the pressure difference ΔP small, and it is necessary to make the piston area A small. However, in the conventional hydraulic shock absorber, since the piston is directly slid along the inner tube, it is difficult in relation to the rigidity required in the front fork to make a diameter of the inner tube small for making the piston area. A small. As a result, it is difficult to set the damping force small.

(2) It is necessary to change the piston dimension in each case that the diameter of the inner tube is changed, at a time when an applied type of motor vehicle of the hydraulic shock absorber is changed. Accordingly, it is impossible to use the piston in common.

### SUMMARY OF THE INVENTION

An object of the present invention is to provide a hydraulic shock absorber in which an inner tube is slidably inserted into an outer tube and an annular oil chamber compartmentalized between an inner periphery of the outer tube and an outer periphery of the inner tube is communicated with an operating oil chamber within the inner tube via an oil hole provided in the inner tube, in which a piston dimension can be set independently from the diameter of the inner tube.

The present invention relates to a hydraulic shock absorber wherein: an inner tube in an axle side is slidably inserted into an outer tube in a vehicle body side. A cylinder is provided in a rising manner in an inner portion of the inner tube. A partition wall member is provided in upper portions of the inner tube and the cylinder. An outer operating oil chamber is compartmentalized between the inner tube in a lower portion of the partition wall member and the cylinder, and an inner operating oil chamber is compartmentalized in an inner portion of the cylinder, respectively, and an oil reservoir chamber is compartmentalized in an upper portion of the partition wall member. A piston support member attached to the outer tube side is inserted to an inner operating oil chamber within the cylinder through the partition wall member. A piston sliding within the cylinder is provided in a leading end portion of the piston support member. The inner operating oil chamber within the cylinder is compartmentalized into a piston rod side oil chamber in which the piston support member is accommodated, and a piston side oil chamber in which the piston rod is not accommodated. An outer operating oil chamber within the inner tube is communicated with a piston rod side oil chamber within the cylinder. An annular oil chamber is compartmentalized between an inner periphery of the outer tube and an outer periphery of the inner tube, and the annular oil chamber is communicated with the outer operating oil chamber within the inner tube via an oil hole provided in the inner tube. A cross sectional area of the annular oil chamber is formed larger than a cross sectional area of the piston support member. The hydraulic shock absorber has a volume compensating flow path which circulates the oil in the inner operating oil chamber or the outer operating oil chamber to the oil reservoir chamber in an expansion side stroke in which the piston support member outgoes from the inner operating oil chamber, and a check valve which prevents the oil flow from the inner operating oil chamber or the outer operating oil chamber to the oil reservoir chamber in the expansion side stroke.

### BRIEF DESCRIPTION OF THE DRAWINGS

The present invention, will be more fully understood from the detailed description given below and from the accompanying drawings which should not be taken to be a limitation on the invention, but are for explanation and understanding only.

FIG. 1 is a cross sectional view showing a whole of a hydraulic shock absorber;

FIG. 2 is an enlarged cross sectional view of a lower portion of FIG. 1;

FIG. 3 is an enlarged cross sectional view of an intermediate portion of FIG. 1;

FIG. 4 is an enlarged cross sectional view of an upper portion of FIG. 1; and

FIG. 5 is an enlarged cross sectional view of a main portion of FIG. 3.

### DESCRIPTION OF THE PREFERRED EMBODIMENTS

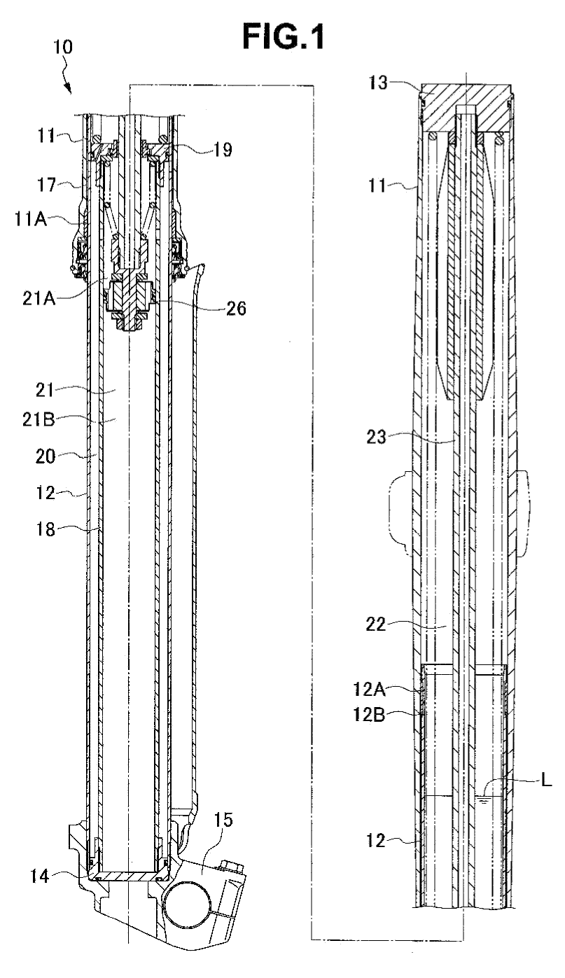

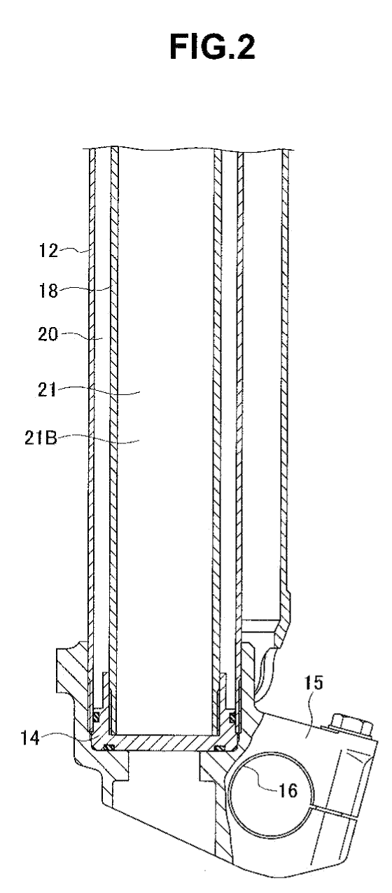

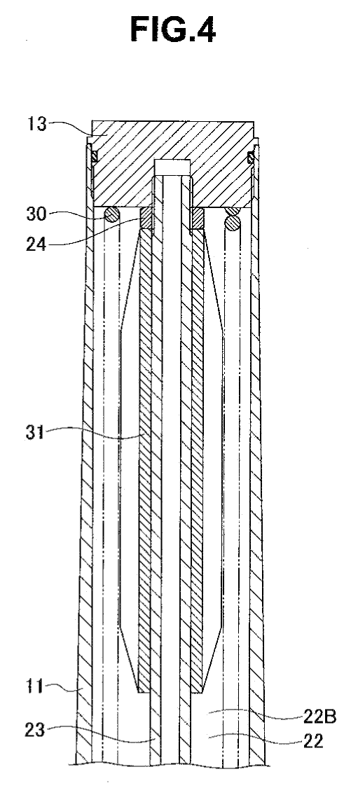

A front fork (a hydraulic shock absorber) 10 is an inverted type font fork in which an outer tube 11 is arranged in a vehicle body side, and an inner tube 12 is arranged in a wheel side, and is structured, as shown in FIGS. 1 to 4, such that the inner tube 12 is slidably inserted to an inner portion of the outer tube 11 via a guide bush 11A fixed to an inner periphery of a lower end opening portion of the outer tube 11, and a guide bush 12A (additionally provided with a seal member 12B in a lower portion of the guide bush 12A in an inner periphery of the inner tube 12) fixed to an outer periphery of an upper end opening portion of the inner tube 12. Reference symbol 11B denotes al oil seal, and reference symbol 11C denotes a dust seal. A cap 13 is screwed in a liquid tight manner to an upper end opening portion of the outer tube 11. A vehicle body side attaching member is provided in an outer periphery of the outer tube 11. A bottom piece 14 and an axle bracket 15 are inserted and attached in a liquid tight manner to a lower end opening portion of the inner tube 12 so as to construct a bottom portion of the inner tube 12, and an axle attaching hole 16 is provided in the axle bracket 15. The bottom piece 14 forming the bottom portion of the inner tube 12 is formed as a dosed-end tubular shape so as to be loaded to an inner diameter step portion of the axle bracket 15. A lower end portion of the inner tube 12 is screwed to an inner diameter of the axle bracket 15, and a lower end surface of the inner tube 12 pinches and retains an outer peripheral step portion of the bottom piece 14 with respect to an inner diameter step portion of the axle bracket 15.

The front fork 10 compartmentalized an annular oil chamber 17 which is compartmentalized by the inner periphery of the outer tube 11, the outer periphery of the inner tube 12, and two guide bushes 11A and 12A.

The front fork 10 is provided with a cylinder 18 in a rising manner in an inner portion of the inner tube 12. A lower end portion of the cylinder 18 is screwed to an inner periphery of the bottom piece 14 so as to come into contact with a bottom surface of the bottom piece 14, and is coaxially arranged with the inner tube 12 in a state of having an annular gap with the inner tube 12.

The front fork 10 is provided with a partition wall member 19 in upper portions of the inner tube 12 and the cylinder 18. The partition wall member 19 is screwed to an upper end outer periphery of the cylinder 18, and is inserted and attached in a liquid tight manner to an inner periphery in an upper end side of the inner tube 12 via a seal member 19A.

The front fork 10 compartmentalizes an outer operating oil chamber 20 between the inner tube 12 in a lower portion of the partition wall member 19 and the cylinder 18, and an inner operating oil chamber 21 in an inner portion of the cylinder 18, and compartmentalizes an oil reservoir chamber 22 in an upper portion of the partition wall member 19. In the oil reservoir chamber 22, a lower region corresponds to an oil chamber 22A (an oil surface L), and an upper region corresponds to an air chamber 22B.

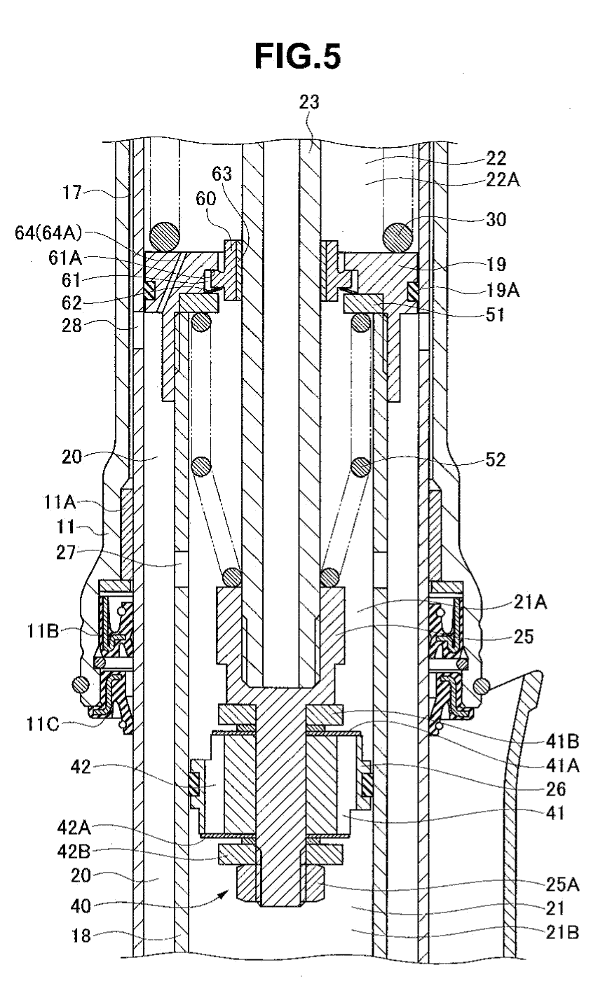

The front fork 10 is structured, as shown in FIG. 5, such that a piston rod 23 attached to the outer tube 11 is inserted to the inner operating oil chamber 21 within the cylinder 18 through the partition wall member 19. Specifically, the piston rod 23 is screwed to a lower end portion in a center portion of the cap 13, and is fixed by a lock nut 24.

The front fork 10 is structured such that a piston 26 sling along an inner periphery of the cylinder 18 is fixed to a piston bolt 25 screwed to a leading end portion of the piston rod 23 inserted to the cylinder 18 from the partition wall member 19, and the inner operating oil chamber 21 is compartmentalized into a piston rod side oil chamber 21A in which the piston rod 23 is accommodated, and a piston side oil chamber 21B in which the piston rod 23 is not accommodated. The piston 26 is fixed by the piston nut 25A.

The front fork 10 normally communicates the outer operating oil chamber 20 within the inner tube 12 with the piston rode side oil chamber 21A of the inner operating oil chamber 21 within the cylinder 18 by an oil hole 27 provided in the cylinder 18.

The front fork 10 normally communicates the annular oil chamber 17 with the outer operating oil chamber 20 within the inner tube 12 via the oil hole 28 provided in the inner tube 12.

The front fork 10 is structured such that a suspension spring 30 is interposed between a lower end surface of the cap 13 provided in the upper end opening portion of the outer tube 11, and an upper end surface of the partition wall member 19 provided in the upper portions of the inner tube 12 and the cylinder 18. A spring guide 31 guiding an inner periphery of the suspension spring 30 is provided in an upper end side outer periphery of the piston rod 23. The front fork 10 absorbs an impact force applied firm a road surface when the vehicle travels on the basis of a stretching vibration of the suspension spring 30.

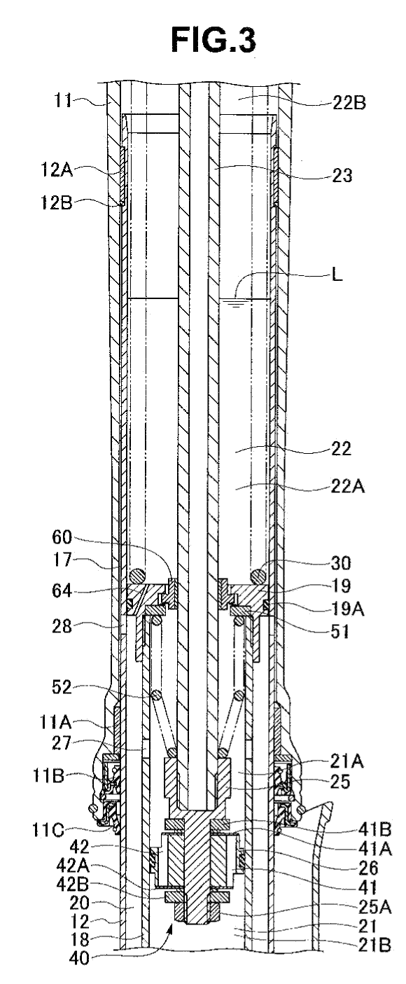

The front fork 10 is provided with a damping force generating apparatus 40 in the piston 26 (FIG. 3).

The damping force generating apparatus 40 is provided with a compression side flow path 41 and an expansion side flow path 42. The compression side flow path 41 is opened and closed by a compression side disc valve 41A (a compression side damping valve) backed up by a valve stopper 41B. The expansion side flow path 42 is opened and closed by an expansion side disc valve 42A (an expansion side damping valve) backed up by the valve stopper 42B. In this case, the valve stopper 41B, the valve 41A, the piston 26, the valve 42A and the valve stopper 42B construct a valve assembly inserted and attached to the piston bolt 25, and is sandwiched by a piston nut 25A screwed to the piston bolt 2,5 so as to be fixed.

The damping force generating apparatus 40 generates a compression side damping force on the basis of a deflection deformation of the compression side disc valve 41A in the compression side stroke. Further, the damping force generating apparatus 40 generates an expansion side damping force on the basis of a deflection deformation of the expansion side disc value 42A, in the expansion side stroke. The stretching vibration of the suspension spring 30 mentioned above is damped by the compression side damping force and the expansion side damping force.

The front fork 10 is structured such that a rebound spring 52 is interposed between an upper end surface of the piston bolt 25 and a spring seat 51 provided in a lower end surface facing to the piston rod side oil chamber 21A of the partition wall member 19 in the upper end side of the cylinder 18. A maximum expansion side stroke is regulated by pressurizing the rebound spring 52 between the upper end surface of the piston bolt 25 and the spring seat 51 at a time of the maximum expansion of the front fork 10.

Accordingly, in the front fork 10, a cross sectional area S1 of the annular oil chamber 17 constituted by the annular gap between the outer tube 11 and the inner tube 12 is formed larger than a cross sectional area (an area surrounded by an outer diameter) S2 of the piston rod 23 (S1>S2, S1≧S2 may be applied).

Further, the partition wall member 19 is provided with a check valve 60 allowing an oil flow from the oil reservoir chamber 22 to the piston rod side oil chamber 21A in the compression side stroke, and inhibiting the oil flow from the piston rod side oil chamber 21A to the oil reservoir chamber 22 in the expansion side stroke. A valve chamber 61 is provided in the partition wall member 19 and an inner periphery of the spring seat 51, and the check valve 60 is accommodated between a step portion 61A in an upper end side of the valve chamber 61 and a backup spring 62 on the spring seat 51 in a lower end side of the valve chamber 61. The check valve 60 is made shorter than an interval between the step portion 61A and the spring seat 51, and is structured such that a horizontal groove is formed in a lower end surface. The check valve 60 is provided so as to be displaceable up and down while coming into slidable contact with an inner periphery of the valve chamber 61. An outer periphery of the check valve 60 forms a flow path allowing the oil flow from the oil reservoir chamber 22 to the piston rod side oil chamber 2IA with respect to the inner periphery of the valve chamber 61. The check valve 60 is provided with a bush 63 slidably supporting the piston rod 23 in a state of being pressure inserted or press fit to an inner periphery thereof. In the compression side stroke, the check valve 60 moves together with the piston rod 23 going into the cylinder 18 5o as to move downward, comes into contact with the spring seat 51, forms a gap with respect to the step portion 61A, and can circulate the oil in the oil reservoir chamber 22 into the piston rod side oil chamber 21A via an outer periphery thereof. In the expansion side stroke, the check valve 60 moves together with the piston rod 23 outgoing from the cylinder 13 so as to move upward, comes into contact with the step portion 61A so as to close the gap with respect to the step portion 61A, and prevents the oil in the piston rod side oil chamber 21A from being discharged to the oil reservoir chamber 22 along an inverted path in the compression side stroke mentioned above.

Further, the partition wall member 19 is provided with a volume compensating flow path 64 circulating the oil in the outer operating oil chamber 20 (the piston rod side oil chamber 21A of the inner operating oil chamber 21 may be applied) to the oil reservoir chamber 22 in the expansion side stroke. The volume compensating flow path 64 is provided with a small flow path 64A.

An operation of the front fork 10 is as follows.

### (Compression Side Stroke)

The operating oil at the approaching volume of the piston rod 23 going into the cylinder 18 in the compression side stroke is transferred to the annular oil chamber 17 from the piston rod side oil chamber 2IA through the oil hole 27 of the cylinder 18, the outer operating oil chamber 20, and the oil hole 28 of the inner tube 12. At this time, since the volume increment amount ΔS1 (the supply amount) of the annular oil chamber 17 is larger than the volume increment amount ΔS2 of the piston rod 23, the shortfall amount (ΔS1−ΔS2) is supplied from the oil reservoir chamber 22 via the check valve 60, in the necessary supply amount, of the oil to the annular oil chamber 17,

In this compression side stroke, the compression side damping force is generated on the basis of the deflection deformation of the compression side disc valve 41A as mentioned above.

### (Expansion Side Stroke)

The operating oil at the outgoing volume of the piston rod 23 outgoing from the inner tube 12 in the expansion side stroke is transferred to the outer operating oil chamber 20 within the inner tube 12 from the annular oil chamber 17 via the oil hole 28 of the inner tube 12. At this time, since the volume decrement amount ΔS1 (the discharge amount) of the annular oil chamber 17 is larger than the volume decrement amount ΔS2 of the piston rod 23, the surplus amount (ΔS1−ΔS2) is discharged to the oil reservoir chamber 22 through the small flow path 64A of the volume compensating flow path 64, in the discharge amount of the oil from the annular oil chamber 17.

In this expansion side stroke, the expansion side damping force is generated on the basis of the deflection deformation of the expansion side disc valve 42A, as mentioned above. Further, the expansion side damping force is generated by the passage resistance of the small flow path 64A mentioned above.

In accordance with the present embodiment, the following operations and effects can be achieved.

(a) In the front fork 10, the operating oil at the approaching volume of the piston rod 23 going into the cylinder 18 hi the compression side stroke is transferred to the annular oil chamber 17 from the oil hole 28 of the inner tube 12 through the outer operating oil chamber 20 from the piston rod side oil chamber 21A. At this time, since the volume increment amount ΔS1 (the supply amount) of the annular oil chamber 17 is larger than the volume increment amount ΔS2 of the piston rod 23, the shortfall amount (ΔS1−ΔS2) is supplied from the oil reservoir chamber 22 via the check valve 60, in the necessary supply amount of the oil to the annular oil chamber 17.

The operating oil at the outgoing volume of the piston rod 23 outgoing from the cylinder 18 in the expansion side stroke is transferred to the outer operating oil chamber 20, and the piston rod side oil chamber 21A by extension from the annular oil chamber 17 through the oil hole 28 of the inner tube 12. At this time, since the volume decrement amount ΔS1 (the discharge amount) of the annular oil chamber 17 is larger than the volume decrement amount ΔS2 of the piston rod 23, the surplus amount (ΔS2−ΔS2) is discharged to the oil reservoir chamber 22 via the small flow path 64A of the volume compensating flow path 64, in the discharge amount of the oil from the annular oil chamber 17.

(b) When the front fork 10 carries out the volume compensating motion mentioned in the item (a), the piston 26 slides along the cylinder 18 in the inner portion of the inner tube 12 without sliding along the inner tube 12. Accordingly, in the case that the diameter of the inner tube 12 is defined on the basis of the relation to the rigidity required in the font fork, the piston area A can be set independently from the diameter of the inner tube 12. Even in the case that the pressure difference ΔP between the piston rod side oil chamber 21A and the piston side oil chamber 21B in both sides of the piston 26 can not be made small on the basis of the relation to the rigidity of the valves 41A and 42A, it is possible to set the piston area A small, make the damping force generated by the damping force generating apparatus 40 of the front fork 10 small, and improve the riding quality of the vehicle.

(c) Even in the case that the applied type of motor vehicle of the front fork 10 is changed, and the diameter of the inner tube 12 is changed, it is possible to make the dimension of the piston 26 unchanged regardless of the diameter of the inner tube 12, and the piston 26 can be used in common.

As heretofore explained, embodiments of the present invention have been described in detail with reference to the drawings. However, the specific configurations of the present invention are not limited to the embodiments but those having a modification of the design within the range of the present invention are also included in the present invention. The check valve 60 in accordance with the present invention is not limited to the structure which allows the oil flow from the oil reservoir chamber 22 to the inner operating oil chamber 21 (the piston rod side oil chamber 21A) in the compression side stroke, and prevents the oil flow from the inner operating oil chamber 21 (the piston rod side oil chamber 214) to the oil reservoir chamber 22 in the expansion side stroke, but may employ a structure which allows the oil flow from the oil reservoir chamber 22 to the outer operating oil chamber 20 in the compression side stroke, and prevents the oil flow from the outer operating oil chamber 20 to the oil reservoir chamber 22 in the expansion side stroke.

Further, the volume compensating flow path 64 in accordance with the present invention is not limited to the structure which circulates the oil in the outer operating oil chamber 20 to the oil reservoir chamber 22 in the expansion side stroke, but may employ a structure which circulates the oil in the inner operating oil chamber 21 (the piston rod side oil chamber 21A) to the oil reservoir chamber 22.

Although the invention has been illustrated and described with respect to several exemplary embodiments thereof it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. A hydraulic shock absorber wherein:
an inner tube in an axle side is slidably inserted into an outer tube in a vehicle body side;
a cylinder is provided in a rising manner in an inner portion of the inner tube;
a partition wall member is provided in upper portions of the inner tube and the cylinder, an outer operating oil chamber is compartmentalized between the inner tube under the partition wall member and the (cylinder, and an inner operating oil chamber is compartmentalized in an inner portion of the cylinder, respectively, and an oil reservoir chamber is compartmentalized over the partition wall member;
a piston support member attached to the outer tube side is inserted to the inner operating oil chamber within the cylinder through the partition wail member, and a piston sliding within the cylinder is provided in a leading end portion of the piston support member;
the inner operating oil chamber within the cylinder is compartmentalized into a piston rod side oil chamber in which the piston support member is accommodated, and a piston side oil chamber in which the piston support member is not accommodated;
the outer operating oil chamber within the inner tube is communicated with the piston rod side oil chamber within the cylinder;
an annular oil chamber is compartmentalized between an inner periphery of the outer tube and an outer periphery of the inner tube, and the annular oil chamber is communicated with the outer operating oil chamber within the inner tube via an oil hole provided in the inner tube;
a cross sectional area of the annular oil chamber is formed larger than a cross sectional area of the piston support member; and
the hydraulic shock absorber has a volume compensating flow path which circulates the oil in the inner operating oil chamber or the outer operating oil chamber to the oil reservoir chamber in an expansion side stroke in which the piston support member moves out from the inner operating oil chamber, and a check valve which prevents the oil flow from the inner operating oil chamber or the outer operating oil chamber to the oil reservoir chamber in the expansion side stroke.

2. A hydraulic shock absorber according to claim 1, wherein said partition wall member is screwed to an upper end outer periphery of said cylinder, and is inserted and attached in a liquid tight manner to an inner periphery in an upper portion of said inner tube via a seal member.

3. Hydraulic shock absorber according to claim 1, wherein said volume compensating flow path and the check valve are provided in said partition wall member.

4. Hydraulic shock absorber according to claim 2, wherein said volume compensating flow path and the check valve are provided in said partition wall member.
